(19) United States
(12) Patent Application Publication
(10) Pub. No.: US 2002/0027510 A1
(43) Pub. Date: Mar. 7, 2002

(54) Apparatus and method for traffic signal flash mode during power outages

(76) Inventors: Dale G. Jones, San Luis Obispo, CA (US); Barbara L. Marcum, San Luis Obispo, CA (US); Jerry A. Williams, Visalia, CA (US); Priscilla Williams, Visalia, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/845,507

(22) Filed: Apr. 30, 2001

Related U.S. Application Data
(60) Provisional application No. 60/200,345, filed on Apr. 28, 2000.

(51) Int. Cl. G08G 1/095

(52) U.S. Cl. 340/907; 340/693.2; 340/635

(57) ABSTRACT

An alternative emergency power supply for LED traffic signal lights. The power supply includes an alternative power source, a power state detector, a circuit transfer switch, and a blink cycle timer and can be mounted on or in a traffic signal head. The power state detector can differentiate between a power failure in a traffic head and a main power supply failure. Upon a power failure, the LED traffic signal light and the alternative power source are disconnected from the main power supply lines. The LED traffic signal light may be 8 or 12 inches in diameter having an S-base, screw-in or Type II design and is placed into a flash mode for between about 12 hours and about 24 hours, or until normal power is restored. A coded signal is communicated to provide indication of a true main power supply failure.

### CROSS-REFERENCE TO RELATED APPLICATION(S)

This application claims the benefit of the filing date of U.S. Provisional Patent Application No. 60/200,345, filed Apr. 28, 2000 and entitled PROCESS AND APPARATUS FOR TRAFFIC SIGNAL OPERATION DURING OUTAGES; the entire contents of which are hereby expressly incorporated herein by reference.

### FIELD OF THE INVENTION

This invention is directed to alternative emergency power supply systems used to operate LED traffic signal lights in a flash mode during a power failure.

### BACKGROUND OF THE INVENTION

Recently, traffic signals have been equipped with arrays of light emitting diodes, or LEDs, instead of incandescent lights. The power requirements of the LEDs are considerably less, consuming 7-20 watts of power to produce a comparable light output intensity as incandescent lights consuming 60-150 watts. These LED arrays are configured to replace incandescent lights without changing the installed housings, mountings, and powering system, and thus are provided as assemblies which are mounted into existing incandescent light sockets and driven by AC power. While providing an energy-conservative, long-life, low-maintenance enhancement to existing traffic lighting systems, LED arrays are just as prone to failure during power outages as incandescent lights. During a power blackout, de-energized traffic lights are unable to warn drivers of an impending hazard or, at minimum, can create perilous confusion at an intersection, with either scenario creating a high risk of accidental injuries and death. Thus, there is a need for a need for a low-cost traffic signal emergency alternative power supply system that automatically detects a power failure and energizes selected LED traffic signal lights to operate in a flash mode using an alternative power source for at least about 12 hours. LED-based traffic lights are particularly suited to being augmented by such emergency power supplies because of their greatly reduced power requirements, relative to incandescent light-based systems.

One such backup system is described in U.S. Pat. No. 5,633,629 issued May 27, 1997 to Hochstein, and entitled “Traffic Information System Using Light Emitting Diodes.” This reference is hereby incorporated herein in its entirety. This system integrates a battery backup power source with the cluster of LEDs in the individual traffic light, which backup is activated by a main AC power loss sensed at the light itself. This source, however, directly drives the LED clusters with DC power, requiring the replacement of the more commonplace LED clusters which are adapted to be driven by AC power with a customize LED light powered by direct current. Furthermore, this customized system does not disconnect the backup power supply and light from the main AC power source, which is especially desirable during lighting system maintenance or repair. Moreover, the system responds to a power loss perceived at the light and not at the AC mains power source, usually located at the street level in an intersection traffic controller cabinet.

Another such backup system is described in U.S. Pat. No. 5,898,389, issued Apr. 27, 1999 to Deese, et al., and entitled “Blackout Backup For Traffic Light.” This reference also is hereby incorporated herein in its entirety. Here, battery-supplied AC power is directed to multiple LED traffic lights by a DC-to-AC inverter, through a plurality of custom-programmed flash block jumper blocks, which are managed by a separate controller unit coupled with the inverter unit. This system employs a large, deep-cycle, gel-type battery in order to energize all of the lights coupled thereto. To initiate emergency blinking during a power outage, the battery must provide AC power to the backup controller, in addition to the traffic lights, in order for the latter to provide the appropriate signal routing through the flash block jumpers. The backup controller energizes power-consuming relays which perform the signal routing to all of the traffic lights energized by this system, and typically is centrally-located in the street-level traffic signal controller cabinet, along with the inverter and the deep-cycle battery. This system is too large and not suitable for local mounting, proximally to the traffic light LED arrays.

There is a need, then, for a compact, low-power alternative emergency power supply system for LED-based traffic lights that is compatible with present LED light array assemblies, which are adapted to be energized with AC power; that senses a true power loss at the street-level traffic controller cabinet; and that disconnects the backup power source and the alternatively-powered lights from the main AC power system.

### SUMMARY OF THE INVENTION

The present invention satisfies the aforementioned needs by providing an apparatus for and method of supplying alternative emergency power to a traffic light. The apparatus is located in proximity with a selected LED light array within a traffic light housing; isolates the backup power supply and the flash mode LED light from the main AC power supply during an outage; and responds to an actual loss of AC power as detected at a remote street-level traffic light controller cabinet. The alternative emergency power system (AEPS) apparatus of this invention can include a circuit transfer switch that isolates the alternative power supply, and the LED light energized thereby, from the AC mains power line; an alternative power source, such as a rechargeable battery; and a blink cycle timer regulating the blink rate and duty cycle during the flash mode of operation. The AEPS apparatus also can include a power state detector, which may use a coded signal received from the street-level controller, to energize the AEPS responsive to a degradation, or loss, of AC power to the street-level controller for a predetermined outage period. In one embodiment, an AEPS could provide an energized traffic light with approximately 55 to 65 blinks-per-minute having a duty cycle of about 10%, for a period of between about 12 to 24 hours, using a 12-volt rechargeable battery with a charge capacity of about 3,200 milliampere-hours. The AEPS can be disposed such that the power state detector, battery and blink timer circuit are sufficiently small to be mounted either inside the traffic signal head itself in proximity with the LED light to be energized thereby, or on an external surface at the back of the traffic signal head assembly.

### BRIEF DESCRIPTION OF THE DRAWINGS

These and other features, aspects and advantages of the present invention will be more fully understood when considered with respect to the following detailed description, appended claims and accompanying drawings, wherein:

FIG. 1 is an illustration of a traffic signal pole with a cantilever support arm used for mounting traffic signal heads;

FIG. 2 is a block diagram of an exemplary embodiment of the present invention, supplying an AC-driven LED traffic light;

FIG. 3a illustrates a front view of a traffic signal head;

FIG. 3b is a partial cut-away view of the inside of a traffic signal head in FIG. 3a, used in accordance with the present invention;

FIG. 3c is an illustration of a top view of the traffic signal head in FIG. 3a and FIG. 3b;

FIG. 4 is a block diagram of an exemplary embodiment of the present invention supplying a DC-driven LED traffic light;

FIG. 5 is a block diagram of a third exemplary embodiment in accordance with the present invention;

FIG. 6 is a schematic of one embodiment of an alternative emergency power supply of the present invention.

### DETAILED DESCRIPTION OF THE INVENTION

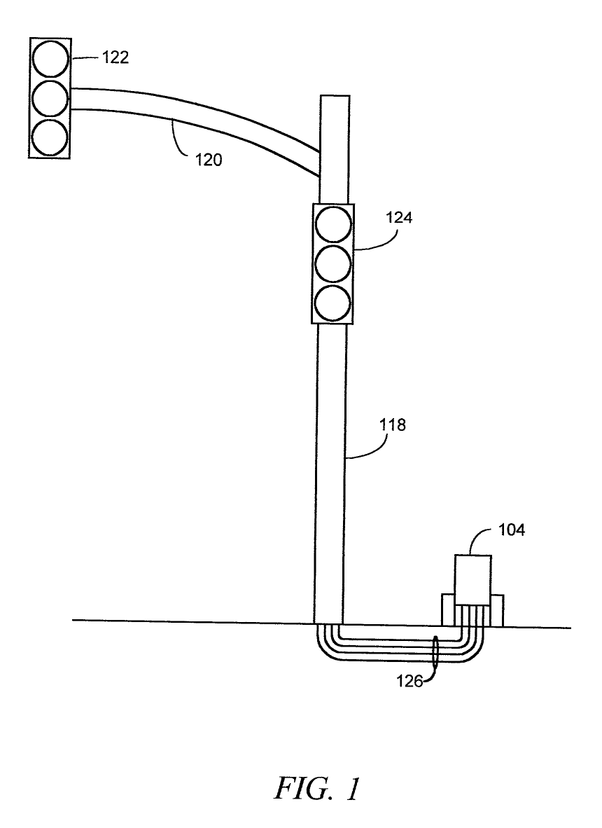

FIG. 1 illustrates a typical traffic light arrangement, in which first traffic light head 124 is mounted upon traffic signal pole 118. A typical traffic signal head includes, oriented from top to bottom, red, amber, and green LED traffic signal lights. For flash mode operation during power outages, the red and/or the amber LED lights are used as the traffic signal lights. Cantilever support arm 120 is also mounted upon pole 118, and is to used support second traffic light head 122. Signalized street-level traffic light controller cabinet 104 receives AC power from a local utility supply, distributes timed power signals via power cables 126, and selectively energizes red, amber and green lights, in accordance with a preselected traffic pattern signal flow, which is responsive to timer, lighting state, roadway sensors such as loop detectors, and counters to evaluate various numbers of motor vehicles in alternate locations. Other signals, such as red, amber, and green turn arrows, may be used in addition to red, amber, and green lights, thus the lights mounted pole 118 may use four or more cables 126, including a neutral cable.

During a power outage, it is preferred that at least one traffic light oriented to one traffic flow direction be operated in a flash mode. In practice, it may be desired by the municipality or governing authority to operate red and/or amber LED signal lights at all traffic signal heads in flash mode during a power outage. A flash mode occurs when at least one LED traffic light continually flashes on and off. Although one light in each of heads 122, 124 may be activated in the flash mode, it also may be desired to have only one light in one of heads 122, 124 operate in the flash mode, for example head 122 on arm 120. Typically, the light selected to operate in the flash mode is a red or amber light, depending upon traffic flow characteristics. For example, at an intersection of two major roads, it may be desirable to have the red light in each head 122, 124, in each pole, oriented to each direction of traffic flow, to operate in the flash mode, defining a four-way emergency stop. As another example, at an intersection of a major road and a side street, it may be desirable to operate in the flash mode, the amber lights in those heads oriented to the major road traffic flow, and the red lights in those heads oriented to the side street traffic flow, urging caution to vehicles along the major road, and requiring side street vehicles to stop before proceeding through the intersection.

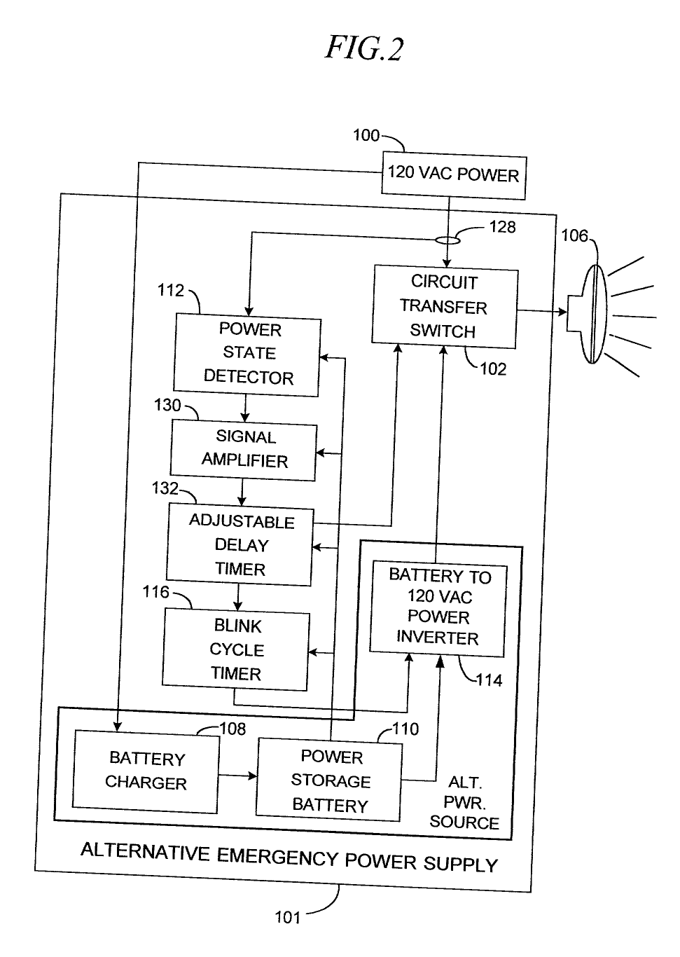

FIG. 2 illustrates a block diagram of one embodiment of the alternative emergency power supply apparatus (AEPS)101. During normal operation of the traffic signal, 120 volt, 60 Hz AC power 100 is supplied, via a circuit transfer switch 102, to a selected LED traffic signal light 106. However, power having alternative voltages and frequencies, such as 240 volt, 50 Hz AC power, also may be supplied, in accordance with the power scheme of the locale. During a power outage, circuit transfer switch 102 uncouples the LED traffic signal light 106 from AC power supply 100, and instead, provides 120 volt AC power from the battery 110 via the DC-to-AC power inverter 114. Circuit transfer switch 102 can employ relays and/or solid state switching devices, such as triacs, to accomplish the desired functionality.

In FIG. 2, the alternative power source is represented by battery charger 108, battery 110, and battery-to-120 VAC power inverter 114. Where the alternative power source includes power storage battery 110, AC power may also be supplied to battery charger 108, preferably maintaining battery 110 in a substantially fully-charged state. Although sealed lead-acid and gel-type batteries may be used, it is preferred that battery 110 be a high power density, rechargeable battery, for example, a nickel metal hydride (NiMH), nickel cadmium (NiCad), nickel-zinc (NiZn) , air-electrode, rechargeable alkaline manganese, iron-silver, or lithium ion battery. In addition, high-capacity capacitive devices, such as supercapacitors, ultracapacitors, and capacitor banks, can be adapted to provide an alternative power source in substitution for, or in combination with, a battery. Ultracapacitors and supercapacitors are two types of electric double-layer capacitors capable of storing large amounts of energy, utilizing ultrathin porous electrodes which in turn encapsulate small quantities of electrolyte, and are well-known in the art. It also is preferred that the alternative power source that is used be capable of supplying power to an LED light, which ordinarily consumes between about 7-20 watts of power, in flash mode, at a rate of about 55 to about 65 flashes per minute, for between about 12-24 hours of continuous backup operation, or longer, if the energy stored in battery 110 so permits. To minimize the size of battery 110, the duty cycle used during flash mode is preferably about 10%. In practice, the duty cycle can be at least about 10% but not more than about 50%. The duty cycle is the “on” time of the LED light expressed as a percentage of the total time between flashes.

Upon the occurrence of a power outage, power sensor 128 transmits a power-loss signal to power failure detector 112. Power sensor 128 may be disposed to monitor the power supplied to all lights housed within a single traffic light head and, thus, may be provided with multiple input channels to accommodate as many inputs as there are signal lights on the signal head, plus the neutral wire. Using this method, the lag time between the onset of a power failure and starting flash mode operation of the selected signal light can be kept to between about 200 to about 300 milliseconds.

It may be desirable to amplify the output of detector 112, using signal amplifier 130. To avoid spurious activation of AEPS 101 during transient, or short-term, power instabilities, adjustable delay timer 132 may be used to forestall flash mode operation for a predetermined period. In one embodiment of the invention, it is preferred that backup power operation be activated after AC power supply 100 degrades to about 20 volts for about 200 milliseconds. After the predetermined delay, circuit transfer switch 102 is activated to isolate light 106 from the AC supply 100, and to couple light 106 with inverter 114 (and thus the alternative power supply), thereby initiating the flash mode blinking of light 106. Blink cycle timer 116 can be coupled with battery 110 and inverter 114 to impose a preselected duty cycle upon the power supplied to light 106. When normal AC power 100 is restored, circuit transfer switch 102 operates to disconnect inverter 114 (and battery 110) from, and to reconnect light 106 to, the AC mains power 100. It is desirable that the traffic signal heads be restored to normal operation when the voltage of AC supply 100 increases to more than about 65 VAC (RMS) for more than about 200 milliseconds.

Once normal power is restored, battery 110 then is recharged via battery charger 108. It is desired that 120 volt AC battery charger 108 only provide a trickle charge, so as not to overheat the battery or destroy it by overcharging. Although “smart” chargers can be used, it is preferred to limit charger 108 output to a trickle current in a range from about 5% to about 10% of the total battery capacity at a supply voltage of between about 10% to about 20% greater than the rated battery voltage. For example, for a 12-volt, 3,200 mAH battery, it is desired that charger 108 supply between about 160 milliamperes to about 320 milliamperes to the battery, at a voltage of between about 13.2 VDC to about 14.4 VDC.

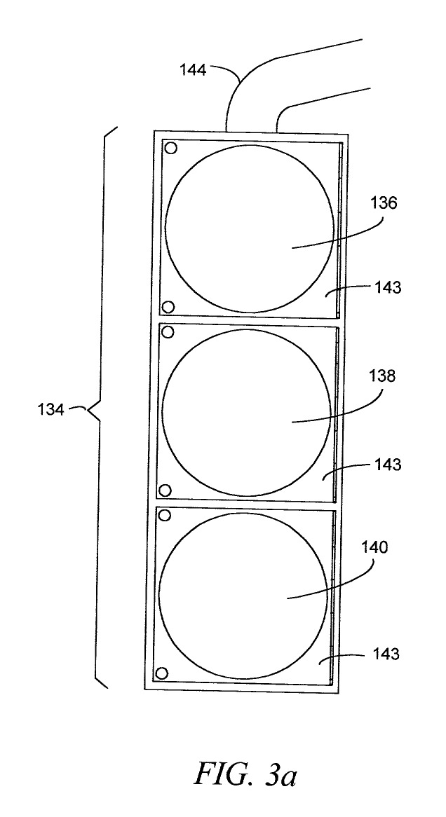

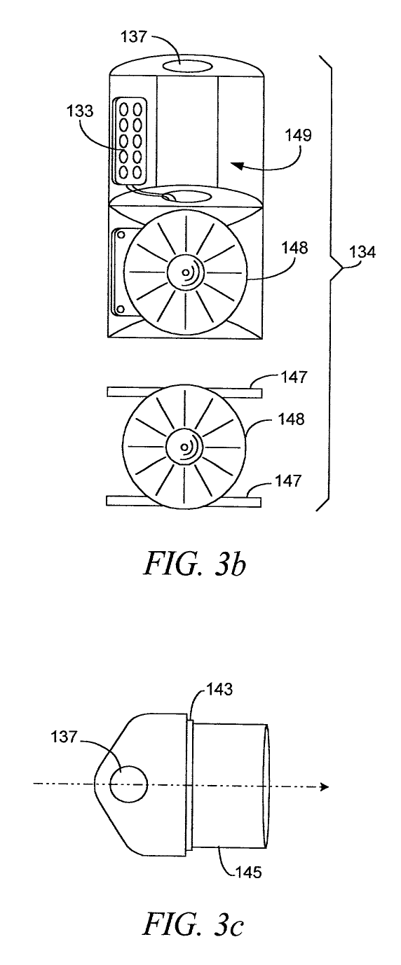

FIGS. 3a, 3b, and 3c are front, cut-away, and top views, respectively, of traffic head 134. In FIG. 3a, exemplary traffic signal head 134 includes red 136, amber 138, and green 140 LED traffic signal lights. Threaded support pipe 144 (about 1.5 inch diameter) is attached to head 134, and is used both for mechanical support and as a protective conduit for the incoming power wires. Pipe 144 is admitted to head 134 via 1.5 inch diameter hole 137 in head 134, seen in FIGS. 3b and 3c.

The topmost light (the red light 136) is contained inside a hinged cover 143 which has cylindrical shield 145 extending several inches and oriented to oncoming traffic, and reducing interference from incident light (e.g., sunlight) which otherwise could obscure the signal light by reelecting from the colored glass or plastic lens. For an 8-inch diameter light, the size of the hinged cover is approximately 10-by-10 inches.

FIG. 3b is a partial cut-away view of the inside of a traffic signal head showing the lamp reflectors 148 with brackets 147 for two of the LED traffic signal lights. In an 8-inch assembly, compartment 149 behind cover 143 is roughly 6 inches deep and tapered at the back. There is ample space on the inside surfaces of head 134 to accommodate terminal strips (not shown) which are normally used to attach power wires to lights 136, 138, 140. Ample space also is available within head 134 to accommodate alternative emergency power system (AEPS) apparatus 133 and it is preferred that AEPS 133 be mounted inside traffic signal head 134, proximal to the light selected to operate in the emergency flash mode (here, red light 136). In some cases, however, the municipality or governing authority may require the APES 133 be mounted externally to traffic signal light head 134. In such cases, it is preferred that AEPS 133 be mounted on the external rear surface of traffic signal head 134 in a weatherproof enclosure (not shown), with the necessary connection wires penetrating the assembly via appropriate electrical conduit for protection.

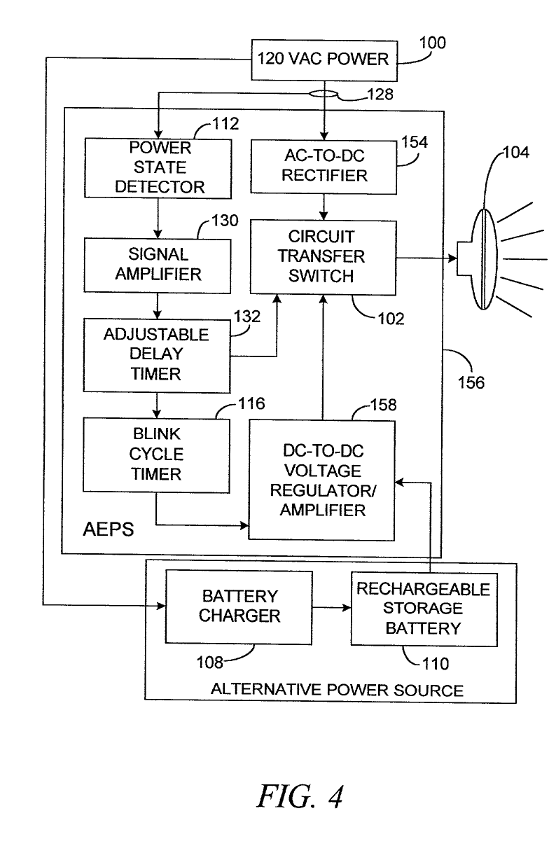

Another preferred embodiment of the present invention is shown in FIG. 4. Presently, LED traffic signal lights (whether S-base or Type II) are designed to operate on 120 VAC power. However, in this case, LED traffic signal light 104 is adapted to operate directly on direct current power. To accommodate direct DC operation of light 104, alternative emergency power supply apparatus 156 can be modified to include AC-to-DC rectifier 154, such as a bridge rectifier, whereby DC power is supplied to light 104 during the normal operational mode. To ensure that the DC voltage characteristics of the power supplied by battery 110 are substantially matched to the DC voltage characteristics required by light 104, a DC-to-DC voltage regulator, or amplifier, 158 may be included in AEPS 156 and coupled with battery 110. If LED light 104 is modified to operate at low DC voltage comparable to battery 110, then the DC-to-DC voltage regulator 158 could optionally be located between AC-to-DC rectifier 154 and circuit transfer switch 102.

Similar to switch 102 in FIG. 1, circuit transfer switch 102 in FIG. 4 is preferred to disconnect LED signal light 104 from the normal 120 VAC power supply 100, and instead, couple power from battery 110 to the LED signal light 104. As in FIG. 1, battery charger 108 can provide a recharging current to battery 110, whenever suitable power is available from AC supply 100.

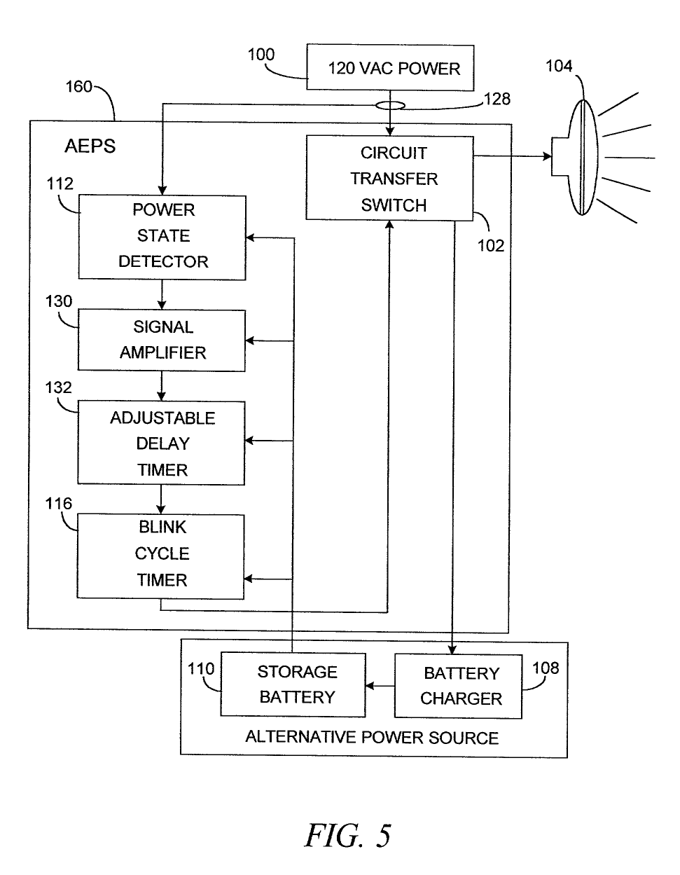

The exemplary embodiment of FIG. 5 illustrates alternative emergency power supply apparatus 160 adapted to energize LED signal light 104 by directing power from battery 110 to circuit transfer switch 102 through blink cycle timer 116. Timer 116 can be adapted to provide sufficient current to drive light 104 by known techniques. Compared to the embodiments of AEPS 101 in FIG. 1 and AEPS 156 in FIG.4, AEPS 160 in FIG. 5 is simplified by eliminating inverter 114 (as in FIG. 1) , or rectifier 154 and regulator 158 (as in FIG. 4). In this configuration, AC power can be supplied to battery charger 108 via circuit transfer switch 102 during normal operation and, during flash mode operation during a power outage, circuit transfer switch 102 also can disconnect battery charger 108 from power supply 100, to minimize the effects of charger 108 upon AEPS 160 operation during flash mode. Once suitable 120-volt, 60-Hz AC power is re-established to supply 100, a restored power signal is provided by sensor 128 which triggers circuit transfer switch 102 to return to the normal mode of operation for LED signal light 104. In this case, LED signal light 104 first is disconnected from battery 110 by disconnecting blink cycle timer 116 from light 104, and then light 104 is reconnected to restored 120 volt AC power supply 100. Finally, battery charger 108 is connected to the battery system to recharge battery 100 using a trickle charge, as described, for example, with regard to FIG. 1.

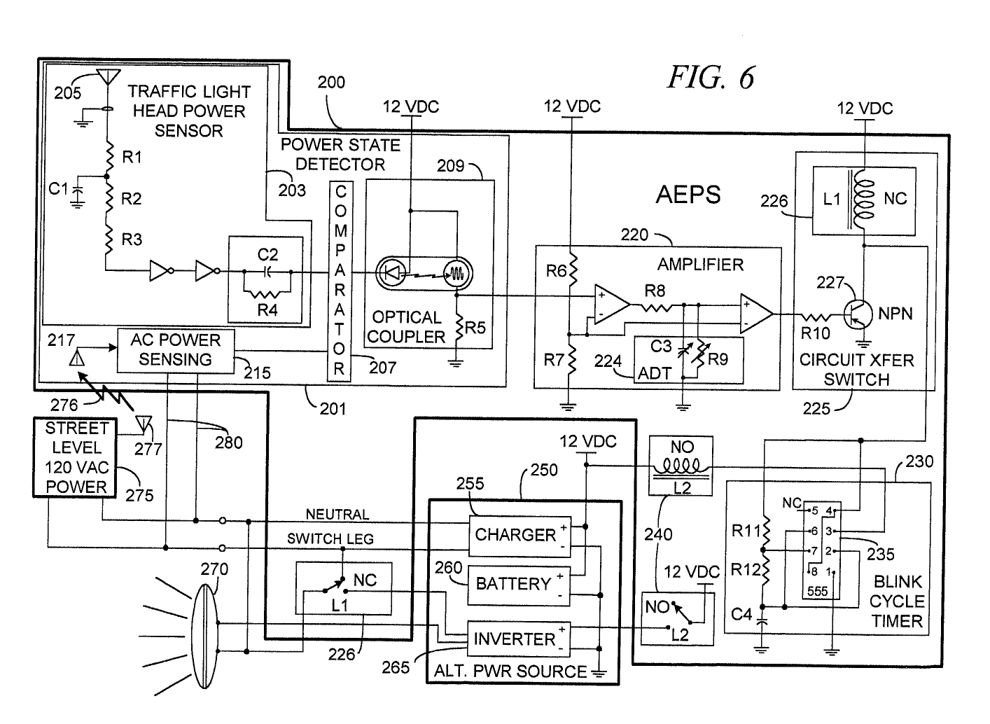

FIG. 6 is a schematic of an exemplary embodiment of alternative emergency power supply (AEPS) apparatus 200, which can include alternative power supply 250 as a component thereof. AEPS 200 can include power state detector 201, signal amplifier 220, adjustable delay timer 224, blink cycle timer 230, and circuit transfer switch 225 incorporating relay 226. Power state detector 201 can be configured to detect power failures both locally, in a traffic light head, using traffic light head power sensor 205, and remotely, using AC power sensing detector 215. Indeed, a preferred embodiment of AEPS 200 is configured to detect power failure both locally and remotely to provide a reliable means of detecting a true electrical power system failure. Sensor 205 can be a shielded antenna made of approximately 6 inches of insulated wire which is secured in parallel with the incoming power feed wires (no grounded or neutral wires), preferably to all of the LED signal lights in the traffic signal head. Merely using sensor 205, by itself, may lead to erroneous indications of power failure, which may initiate the flash mode of operation when such operation is undesirable, for example, when a signal light burns out, or if the traffic light pole is partially destroyed in an accident. Although such a power failure would be detected locally at traffic light head in the affected sensor 205, it would not be a true power failure, and the flash mode should not be initiated in the other red signal lights at the same intersection. Thus, it also is desirable to confirm the occurrence of a true power failure by also remotely sensing a power failure at the intersection controller cabinet which supplies power to the traffic light head. Remote sensing can be accomplished by employing a street-level AC power failure detector 275 within the intersection controller cabinet to transmit main power failure signal 276 to AC power sensing detector 215 in power state detector 201. Signal 276 may be emitted via transmitter antenna 277 and sensed via receiver antenna 217 coupled with detector 215. Alternatively, a similar signal may be communicated between detector 275 and detector 215 by wires disposed therebetween. It is desirable that, if the street level 120 VAC power voltage drops below about 20 VAC for a period of about 700 milliseconds, detector 275 transmits signal 276, preferably a coded signal, to power state detectors 201 located in the traffic signal heads corresponding to the particular intersection controller cabinet transmitting signal 276. Only those traffic signal heads equipped with AEPS 200 would respond to this coded signal. A small rechargeable battery or capacitive device can be disposed within detector 275 to provide the power required to transmit the coded signal during a power outage. At each corresponding traffic signal head equipped with AEPS 200, traffic light head sensor 215 monitors the input power supply voltage to the corresponding traffic light 270. If the input power supply voltage in light 270 drops below a preselected voltage for a predetermined period, detector 201 activates a code signal receiver in comparator 207. If a valid code signal is received, circuit transfer switch 225 is activated to disconnect the selected signal light 270 from the corresponding intersection cabinet controller 120 VAC power supply.

In particular, at a preselected loss voltage, comparator 207 transmits a flash mode select signal via optical coupler 209 to amplifier 220. A suitable optical coupler includes the MarkTech MT-1030-WT. After a predetermined (adjustable) delay period, amplifier 220 passes the select signal to the gate of NPN transistor 227 which, in turn, causes normally closed relay L1 226 to deactivate and change state. Suitable amplifiers include the standard TL082CP amplifier. When L1 226 is activated, 120 VAC power is supplied to light 270 via street-level 120 VAC power 275. When L1 226 is deactivated, light 270, AEPS 200, and alternative power supply 250 are disconnected from the street-level 120 VAC power in the intersection controller cabinet. Light 270 is then connected to AEPS 200 and battery 260 via inverter 265, which then supplies sufficient AC power to operate light 270 in flash mode. An advantage of this auto-disconnect feature is to prevent electrical shock to traffic system repair personnel who might be in contact with the electrical system during a power outage.

Due to the large number of traffic signal system manufacturers, each with different types of traffic signals and each having different voltage transients, harmonic distortion levels, and filtering systems contained at the intersection controller cabinet 104, it is desirable to provide a unique code corresponding to a particular intersection controller cabinet and its associated light heads. Coded signals can be transmitted and received using well-known transistor-to-transistor logic (TTL) communication techniques. Moreover, the power outage system code is preferred to be a fifteen bit code that can be selected and set by an intersection system maintenance crew, or transmitted to the controller from a central control office by way of a wireless transmission technique, or by sending coded signals across the traffic light system power transmission lines. The code can be changed from intersection to intersection to avoid interference from other transmitted signals or along the power lines between intersections.

It also may be desirable to provide more than one coded signal to afford secure operation of the traffic light system and, optionally, to provide differential operation of signal lights. For example, one particular coded signal may activate the flash mode for the amber LED traffic signal lights along the main highway, while a second coded signal may activate the flash mode in the red LED traffic signal lights along the side street intersections during a power outage. By proper selection of the coded signal at the traffic signal heads, such distinctions between main highway amber LED flash mode and side street red LED flash mode can be accommodated.

Deactivation of relay L1 226 can initiate flash mode operation by triggering blink cycle timer 230, which may include a simple 555 timer circuit 235. By selecting suitable values for R11, R12, and C4, blink cycle timer can produce a cyclic output signal which generates a flash rate of between about 55 to about 65 flashes per minute, with an LED light 270 duty cycle of about 10%, although other flash rates and duty cycles may be selected in accordance with industry standards, local vehicular codes, and operational constraints. Red LED signal lights such as a 8-inch Electro-Techs Model RD-08FM can be used as light 270. Timer 235 provides its cyclic output signal to relay L2 240, which is normally open. Relay L2 240 alternatingly activates and deactivates inverter 265, responsive to the cyclic output signal, thus operating light 270 in the flash mode at the aforementioned blink rate and duty cycle. A suitable power inverter includes Samlex America Model SI-50HP.

When suitable power, at a preselected restore voltage, is available to the intersection controller cabinet 275, after a predetermined restore delay period, a normal mode select signal is transmitted to detector 215, which causes comparator 207 to discontinue transmissions to circuit transfer switch 225 and, in turn, returns relay L1 226 to its normal operational state (NC). By returning to the normally closed state, relay L1 226 disconnects AEPS 200, in particular blink cycle timer 230, battery 260, and inverter 265, from light 270, and connects light 270 to street level 120 VAC power 275. At the same time, AC power is returned to charger 255, providing battery 260 with a suitable recharging current, as previously discussed. In addition, deactivation of relay L2 240 also deactivates inverter 265.

The preselected loss and restore voltages can be adjusted by selecting determinable values for R1, R2, R3, and C1 in detector 201; similarly the predetermined loss and restore delay period can be adjusted by selecting determinable values for R9 and/or C3 in the adjustable delay timer 224, which can be disposed in signal amplifier 220. In one embodiment of AEPS 200, the preselected voltage is preferred to be about 20 VAC, and the predetermined period about 200 milliseconds. Exemplary values for the constituent resistors and capacitors illustrated in AEPS 200 are provided in TABLE 1.

TABLE 1
Approx. Component Values for FIG. 6

| | | | | | |
|---|---|---|---|---|---|
| R1 | 8.2 | MΩ | R7 | 49 | kΩ |
| R2 | 100 | kΩ | R8 | 10 | kΩ |
| R3 | 4.7 | kΩ | R9 | 270 | Ω |
| R4 | 270 | Ω | R10 | 1.0 | kΩ |
| R5 | 10 | kΩ | R11 | 120 | kΩ |
| R6 | 49 | kΩ | R12 | 12 | kΩ |
| C1 | 1.0 | μF | C3 | 4.7 | μF |
| C2 | 1.5 | μF | C4 | 10 | μF |

It is desirable that the intersection control cabinet be equipped with a manual test switch, which allows the maintenance personnel to test the battery backup flash mode operation. Such a test would be initiated by operating the test switch, and verifying that all the LED signal lights connected with the battery backup system go into flash mode operation.

Two power state verification modes can be employed to determine whether a power failure has occurred. In the first mode, as described previously, the input power to the intersection controller cabinet is monitored, and a coded signal is sent to associated AEPS-equipped traffic signal heads when a failure occurs in the main 120 VAC power at the street level. In the second mode, a coded signal is continuously sent from the intersection controller cabinet to associated AEPS-equipped traffic signal heads provided suitable power is available to the cabinet. If a power failure occurs, the coded signal is no longer sent. In the second mode, the circuitry at the intersection controller cabinet does not require a battery or a super capacitor power source, because upon a power failure, the coded signal transmission simply stops. In this latter verification mode, power state detector at the traffic signal heads would continue normal operation so long as the coded signal was still being received from the intersection traffic controller, but would initiate flash mode when the coded transmissions cease. This verification mode also would prevent spurious flash mode operation, for example, if one of the signal lights burned out

There are a large number of other means to detect power failure and trigger operation of flash mode at signalized intersections. For example, a street-level power failure to the controller cabinet can be detected by a radio frequency power failure detector, a current transformer, a photocell detector, a CMOS timer chip, an opto-coupler, hall effect device, and the like.

Additionally, there are a number of methods for transmitting a coded signal from the intersection controller cabinet 275 to detector 201 in associated AEPS-equipped signal heads, including without limitation, AM, FM, UHF, VHF, shortwave, microwave, and infrared signals, alone or in combination, which can be transmitted and received using well-known wireless or wired channel techniques, as appropriate.

The above descriptions of exemplary embodiments of the traffic signal alternative emergency power supply systems provided in accordance with practice of the present invention are for illustrative purposes only. Because of the myriad of variations that will be apparent to those skilled artisans, the present invention is not intended to be limited to the particular embodiments described above. The scope of the invention is defined in the following claims.

What is claimed is:

1. An alternative emergency power supply for an LED traffic signal light in a traffic signal head having a main power supply, comprising:
a. an alternative power source;
b. a power state detector operably coupled with the main power supply, monitoring the main power supply and providing a loss signal responsive to a loss of the main power supply;
c. a circuit transfer switch operably coupled with the power state detector circuit, the alternative power source, the main power supply, and the LED traffic signal light, reversibly switching the LED traffic signal light between the main power supply and the alternative power source, responsive to the loss signal; and
d. a blink cycle timer coupled with the alternative power source and the circuit transfer switch, cyclically causing the LED traffic signal light to operate in a flash mode at a predetermined flash rate with a predetermined duty cycle in response to the loss signal.

2. The alternative emergency power supply of claim 1, wherein the alternative power source comprises one of a rechargeable battery, a capacitive device, and a combination thereof.

3. The alternative emergency power supply of claim 2, wherein the rechargeable battery is one of a nickel metal hydride battery, a nickel cadmium battery, a nickel zinc battery, a rechargeable alkaline manganese battery, an air-electrode battery, an iron-silver battery, a lithium ion battery, a lead-acid battery, and a gel battery, used alone or in combination with the capacitive device; and the capacitive device comprises one of a supercapacitor, an ultracapacitor, and a capacitor bank, used alone or in combination with the rechargeable battery.

4. The alternative emergency power supply of claim 3, wherein the alternative power source has an equivalent energy storage capacity of between about 1200 milliampere-hours and about 6000 milliampere-hours.

5. The alternative emergency power supply of claim 2, wherein the alternative power source has an energy storage capacity sufficient to operate the LED traffic signal light in the flash mode for at least about 12 hours.

6. The alternative emergency power supply of claim 5, wherein the alternative power source has an energy storage capacity sufficient to operate the LED traffic signal light in the flash mode for at least about 24 hours.

7. The alternative emergency power supply of claim 1, wherein the power state detector is adapted to generate the loss signal responsive to a coded signal transmitted from an intersection controller cabinet in response to the loss of the main power supply.

8. The alternative emergency power supply of claim 7, wherein the coded signal is communicated using one of a wireless communication technique and a wire-based communication technique.

9. The alternative emergency power supply of claim 8, wherein the communication technique comprises one of an AM, FM, UHF, VHF, shortwave radio, microwave, infrared, powerline-carrier signal, and TTL-coded communication technique.

10. The alternative emergency power supply of claim 1, wherein said power state detector further monitors a LED traffic signal light power supply at the traffic head; and provides the loss signal if the main power is less than a first preselected voltage for a first predetermined period, and the traffic light power supply is less than a second preselected voltage for a second predetermined period.

11. The alternative emergency power supply of claim 10, wherein the a first preselected voltage is about 20 VAC, the first predetermined period is about 700 milliseconds, the second preselected voltage is about 20 VAC, and the second predetermined period is about 200 milliseconds.

12. The alternative emergency power supply of claim 10, wherein the power state detector provides a restore signal responsive to a restoration of the main power supply as indicated by a main power supply voltage of at least about 65 VAC (RMS) for a period of at least about 200 milliseconds; and wherein the circuit transfer switch switches the LED traffic signal light back to the main power supply, responsive to the restore signal.

13. The alternative emergency power supply of claim 7, wherein the coded signal comprises a predetermined fifteen-bit code; and wherein a selected plurality of LED traffic signal lights are responsive to the predetermined fifteen-bit code by operating in the flash mode.

14. The alternative emergency power supply of claim 1, wherein the predetermined flash rate is between about 55 blinks per minute and about 65 blinks per minute; and the predetermined duty cycle is between about 10% and about 50%.

15. The alternative emergency power supply of claim 1, wherein the circuit transfer switch isolates the LED traffic signal light from the main power supply during the loss of the main power supply.

16. The alternative emergency power supply of claim 1, wherein the circuit transfer switch is one of a relay and a triac.

17. The alternative emergency power supply of claim 4, wherein the LED traffic signal light is about 8 inches in diameter and rated for about 7 watts; and wherein the rechargeable battery is a 12-volt DC nickel metal hydride battery having an energy capacity rating of about 3,200 milliampere-hours.

18. The alternative emergency power supply of claim 4, wherein the LED traffic signal light is about 8 inches in diameter and rated for about 7 watts; and wherein the rechargeable battery is a 12-volt DC nickel metal hydride battery having an energy capacity rating of about 1,800 milliampere-hours, sufficient to operate the LED traffic signal light in the flash mode for at least about 24 hours.

19. The alternative emergency power supply of claim 4, wherein the LED traffic signal light is about 12 inches in diameter and rated for about 20 watts; and wherein said rechargeable battery is a 12 volt DC nickel metal hydride battery having an energy capacity of about 5,000 milliampere-hours, sufficient to operate the LED traffic signal light in the flash mode for at least about 24 hours.

20. The alternative emergency power supply of claim 1, wherein the alternative power source further comprises a 12-volt DC power inverter coupled with the LED traffic signal light.

21. The alternative emergency power supply of claim 20, wherein the alternative power source further comprises a 12-volt DC recharger electrically coupled with LED traffic signal light, restoring an energy charge to the alternative power source while the main power supply is operable.

22. The alternative emergency power supply of claim 1, wherein the alternative emergency power supply components are mounted on the traffic signal head.

23. The alternative emergency power supply of claim 22, wherein the alternative emergency power supply components are mounted inside the traffic signal head.

24. The alternative emergency power supply of claim 1, wherein the LED traffic signal light is one of a red LED traffic signal light and an amber LED traffic signal light.

25. A method for operating an LED traffic signal light in a flash mode during loss of a main power supply, comprising:
a. detecting a main power state;
b. disconnecting the LED traffic signal light from the main power supply switch leg using a circuit transfer switch;
c. energizing the LED traffic signal light using an alternative power source; and
d. activating a blink cycle timer coupled with the alternative power source and supplying cyclic power to the LED traffic signal light, thereby causing the LED traffic signal light to operate in a flash mode.

26. The method of claim 25, wherein energizing the LED traffic signal light comprises supplying AC power to the light by inverting DC power from the alternative power source.

27. The method of claim 26, wherein the AC power is 120 VAC power and the DC power is 12 VDC.

28. The method of claim 26, wherein the alternative power source operates the LED traffic signal light in the flash mode for at least 12 hours.

29. The method of claim 27, wherein the alternative power source operates the LED traffic signal light in the flash mode for at least 24 hours.

30. The method of claim 25, wherein detecting the main power state comprises an associated traffic signal head receiving a coded signal communicated from an intersection controller cabinet responsive to the state of the main power supply.

31. The method of claim 30, wherein the coded signal is communicated when a main power supply failure is detected at the intersection controller cabinet.

32. The method of claim 30, wherein said coded signal is communicated during normal operation of the main power supply, and not communicated during a failure of the main power supply.

33. The method of claim 30, wherein coded signal communication uses one of AM, FM, UHF, VHF, shortwave radio, microwave, infrared, powerline carrier signal, and TTL-coded signal communication techniques.

34. The method of claim 30, wherein said coded signal is communicated to a plurality of traffic signal heads at a signalized intersection.

35. The method of claim 31, wherein the main power supply failure is detected at the intersection controller cabinet when the main power supply voltage is less than about 20 VAC for a period of more than about 700 milliseconds.

36. The method of claim 34, wherein the main power supply failure is detected when power supply voltage at the traffic signal head is less than about 20 volts for a period of more than about 200 milliseconds.

37. The method of claim 25, wherein the LED traffic signal light is returned to normal operation when a main power supply voltage of at least about 65 VAC (RMS) is detected for a period of at least about 200 milliseconds in the intersection controller cabinet.

38. The method of claim 30, wherein the coded signal is a fifteen-bit code.

39. The method of claim 38, wherein the fifteen-bit code is unique to a particular intersection controller cabinet, and selected LED traffic signal lights respond thereto.

40. The method of claim 25, wherein the flash mode comprises blinking the LED traffic signal light at a rate of between about 55 and about 65 times per minute with a duty cycle of between about 10% and about 50%.

41. The method of claim 25, wherein the LED traffic signal light is one of a red signal light and an amber signal light rated for about 7 watts, and is operated in the flash mode for at least about 12 hours using a 12-volt DC rechargeable battery rated for approximately 3,200 milliampere-hours.

42. The method of claim 25, wherein the LED signal light is one of a red signal light and an amber signal light rated for about 7 watts, and is operated in the flash mode for at least about 24 hours using a 12-volt DC rechargeable battery rated for approximately 1,800 milliampere-hours.

43. The method of claim 25, wherein the LED traffic signal light is one of a red signal light and an amber signal light rated for about 20 watts, and is operated in the flash mode for at least about 24 hours using a 12-volt DC rechargeable battery rated for approximately 5,000 milliampere-hours.

44. The method of claim 25, further comprising disconnecting the LED traffic signal light from the alternative power source and reconnecting the LED traffic signal light to the main power supply, thus restoring normal operation of the LED traffic signal head, when voltage of the main power supply is at least about 65 VAC (RMS) for at least about 200 milliseconds.

45. The method of claim 44, further comprising recharging the alternative power source during normal operation using power from the LED traffic signal light.

46. An alternative emergency power supply for an LED traffic signal light in a traffic signal head having a main power source supplied from an intersection controller cabinet, comprising:
a. an alternative power source, including:
(1) a direct current energy store having one of a rechargeable battery, a capacitive device, and a combination thereof;
(2) a charger coupled with the main power supply and selectively restoring electrical energy to the direct current energy store; and
(3) an inverter coupled with the direct current energy store and generating an alternating current suitable for driving the LED traffic signal light;
b. a power state detector operably coupled with, and monitoring, the power supply, the power state detector including:
(1) a remote power failure sensor and a remote power failure signal transmitter in the intersection controller cabinet, the transmitter communicating a remote power failure signal when a voltage of the main power supply falls to a first preselected voltage after a first preselected period;
(2) a local power failure sensor in the traffic signal head and communicating a traffic head power failure signal when a voltage of the traffic head power supply falls to a second preselected voltage after a second preselected period; and
(3) a comparator, having a remote power failure signal receiver therein, the comparator evaluating the remote power failure signal and the traffic head power signal, and providing a loss signal responsive to an actual main power failure;
c. a circuit transfer switch operably coupled with the power state detector, the alternative power source, the main power supply, and the LED traffic signal light, reversibly switching the LED traffic signal light between the main power supply and the alternative power source, responsive to the loss signal;
d. an adjustable delay timer coupled between the power state detector and circuit transfer switch, delaying the switching operation of the circuit transfer switch from the main power supply to the alternative power source for a predetermined period to minimize spurious operation of the alternative emergency power supply by a power loss shorter than the predetermined period; and
e. a blink cycle timer coupled with the alternative power source and the circuit transfer switch, cyclically causing the LED traffic signal light to operate in a flash mode at a predetermined flash rate with a predetermined duty cycle in response to the loss signal.

47. The alternative emergency power supply of claim 46, wherein the rechargeable battery is one of a nickel metal hydride battery, a nickel cadmium battery, a nickel zinc battery, a rechargeable alkaline manganese battery, an air-electrode battery, an iron-silver battery, a lithium ion battery, a lead-acid battery, and a gel battery, used alone or in combination with the capacitive device; and the capacitive device comprises one of a supercapacitor, an ultracapacitor, and a capacitor bank, used alone or in combination with the rechargeable battery.

48. The alternative emergency power supply of claim 47, wherein the alternative power source has an equivalent energy storage capacity of between about 1200 milliampere-hours and about 6000 milliampere-hours.

49. The alternative emergency power supply of claim 46, wherein the alternative power source has an energy storage capacity sufficient to operate the LED traffic signal light in the flash mode for at least about 12 hours.

50. The alternative emergency power supply of claim 46, wherein the alternative power source has an energy storage capacity sufficient to operate the LED traffic signal light in the flash mode for at least about 24 hours.

51. The alternative emergency power supply of claim 46, wherein the remote power failure transmitter generates a coded signal indicative of the power state of the main power supply provided to the intersection controller cabinet.

52. The alternative emergency power supply of claim 51, wherein the coded signal is communicated using one of a wireless communication technique and a wire-based communication technique.

53. The alternative emergency power supply of claim 52, wherein the communication technique comprises one of an AM, FM, UHF, VHF, shortwave radio, microwave, infrared, powerline-carrier signal, and TTL-coded communication techniques.

54. The alternative emergency power supply of claim 46, wherein the first preselected voltage is about 20 VAC, the first predetermined period is about 700 milliseconds, the second preselected voltage is about 20 VAC, and the second predetermined period is about 200 milliseconds.

55. The alternative emergency power supply of claim 46, wherein the power state detector provides a restore signal responsive to a restoration of the main power supply as indicated by a main power supply voltage of at least about 65 VAC (RMS) for a period of at least about 200 milliseconds; and wherein the circuit transfer switch switches the LED traffic signal light back to the main power supply, responsive to the restore signal.

56. The alternative emergency power supply of claim 51, wherein the coded signal comprises a predetermined fifteen-bit code; and wherein a selected plurality of LED traffic signal lights are responsive to the predetermined fifteen-bit code by operating in the flash mode.

57. The alternative emergency power supply of claim 46, wherein the predetermined flash rate is between about 55 blinks per minute and about 65 blinks per minute; and the predetermined duty cycle is about 10%.

58. The alternative emergency power supply of claim 46, wherein the circuit transfer switch isolates the LED traffic signal light from the main power supply during the loss of the main power supply.

59. The alternative emergency power supply of claim 46, wherein the circuit transfer switch is comprised of one of a relay and a triac.

60. The alternative emergency power supply of claim 48, wherein the LED traffic signal light is about 8 inches in diameter and rated for about 7 watts; and wherein the rechargeable battery is a 12-volt DC nickel metal hydride battery having an energy capacity rating of about 3,200 milliampere-hours.

61. The alternative emergency power supply of claim 48, wherein the LED traffic signal light is about 8 inches in diameter and rated for about 7 watts; and wherein the rechargeable battery is a 12-volt DC nickel metal hydride battery having an energy capacity rating of about 1,800 milliampere-hours, sufficient to operate the LED traffic signal light in the flash mode for at least about 24 hours.

62. The alternative emergency power supply of claim 48, wherein the LED traffic signal light is about 12 inches in diameter and rated for about 20 watts; and wherein said rechargeable battery is a 12 volt DC nickel metal hydride battery having an energy capacity of about 5,000 milliampere-hours, sufficient to operate the LED traffic signal light in the flash mode for at least about 24 hours.

63. The alternative emergency power supply of claim 46, wherein the LED traffic signal light is a S-base type screw-in signal light having a diameter of one of about 8 inches and about 12 inches.

64. The alternative emergency power supply of claim 46, wherein the LED traffic signal light is a Type-II LED traffic signal light having a diameter of one of about 8 inches and about 12 inches.
